(19) United States
(12) Patent Application Publication
(10) Pub. No.: US 2020/0338878 A1
(43) Pub. Date: Oct. 29, 2020

(54) METHOD FOR MANUFACTURING LIGHTWEIGHT HIGH-STRENGTH MATERIAL USING MIDDLE FRAGMENT OF SHELL

(71) Applicant: HANBAT NATIONAL UNIVERSITY INDUSTRY-ACADEMIC COOPERATION FOUNDATION, Daejeon (KR)

(72) Inventors: Sang-Mo SHIN, Daejeon (KR); Jeoung Woo KIM, Daejeon (KR)

(73) Assignee: HANBAT NATIONAL UNIVERSITY INDUSTRY-ACADEMIC COOPERATION FOUNDATION, Daejeon (KR)

(21) Appl. No.: 16/617,715

(22) PCT Filed: May 31, 2018
(86) PCT No.: PCT/KR2018/006227

§ 371 Date: Mar. 5, 2020

(30) Foreign Application Priority Data
May 31, 2017 (KR) 10-2017-0067978

(51) Int. Cl. B32B 37/02; B32B 37/12; B32B 43/00; B32B 37/06; B32B 37/10; C09J 163/00; C09J 175/04

(52) U.S. Cl. CPC B32B 37/02; B32B 37/12; B32B 43/00; B32B 37/06; B32B 37/10; C08K 7/14; C09J 175/04; B32B 2307/718; B32B 2317/00; B32B 2307/54; C09J 163/00

(57) ABSTRACT

The present invention relates to a method for manufacturing a lightweight high-strength material using a shell fragment and to a material. According to the present invention, fragments are collected from shells and are laminated or aligned in a regular array using an adhesive, thereby manufacturing a material that is light and has excellent mechanical characteristics. The present invention is advantageous in that use of waste shells reduces related costs and solves environmental problems.

### TECHNICAL FIELD

The present invention generally relates to method for manufacturing lightweight high-strength material using middle fragments of shell and, more particularly, to method for making tablets from shells to laminate and rearrange them using adhesives.

### BACKGROUND ART

Lightweight strong materials are necessary in most of the industries such as automobile, aerospace, electronics, telecommunication, military, etc. Lightweight bulletproof materials with excellent mechanical properties are needed especially in the military industry. However, currently available materials such as boron carbide, silicon carbide, etc. are not very available because of their high prices. Natural materials with lightweight bulletproof properties and better mechanical properties are available though so are various artificial materials too.

The shell of shellfish that has evolved over hundreds of millions of years is one of the natural materials and has excellent mechanical properties in terms of weight and thickness. For instance, the shell has the specific gravity of about 2.6, similar to that of boron carbide and less than that of silicon carbide and aluminum nitride.

The shell has excellent mechanical properties owing to its ‘brick and mortar’ structure that looks like the lamination of thousands of about 0.5 μm thin brick-like tablets. When external force is applied to the shell, its crack can be expected to go along among micro-tablets but the applied external force and energy to the shell are actually absorbed due to its peculiar structure so that its crack cannot keep going along further but stop in the middle. However, it is difficult at the moment to reproduce the natural ‘brick and mortar’ structure of the shell because it is not easy for human to laminate thousands of micro-tablets.

Furthermore, recently the amount of the shells dumped on the coast every year reaches 500,000 tons, it causes environmental pollution including serious water pollution. Shells are the natural materials with great usability, and it is necessary to actively utilize them so as to prevent environmental pollution.

### DISCLOSURE

### Technical Problem

The present invention advantageously provides a method for manufacturing lightweight material with excellent mechanical properties out of the shells which are one of the natural waste resource.

### Technical Solution

In an embodiment of the present invention, a method for manufacturing lightweight high-strength material comprises the steps of: making tablets out of shells, and laminating and rearranging the tablets.

Preferably, the laminated and rearranged structure is hierarchical structure.

Preferably, the tablets are adhered with an adhesive so as to be laminated and rearranged. The adhesive is epoxy or urethane-based adhesive. The adhesive further includes fiber fragments made from glass or carbon. The tablets are laminated and rearranged using the adhesive and the prepregs made from glass fiber or carbon fiber together.

Furthermore, in another embodiment of the present invention, a lightweight high-strength material is manufactured in the method of the above embodiment.

### Advantageous Effects

According to the present invention, lightweight high-strength material is manufactured by making tablets out of shells and laminating and rearranging them, so that it can be applied to various industries and environmental problems can be solved at the same time.

### DESCRIPTION OF DRAWINGS

FIG. 1 depicts a conceptual view of making tablets from shells according to an embodiment of the present invention;

FIG. 2 depicts a cross-section view of laminating and rearrange the tablets made as shown FIG. 1 in zigzag;

FIG. 3 shows strips of shells cut from a shell, thinned strips, and a lightweight high-strength board made by laminating the tablets made from the strips according to the embodiment of the present invention;

FIG. 4 shows final boards made by laminating the tablets and examples of arrangements of the tablets according to the embodiment of the present invention; and

FIG. 5 shows the results of 3-point bend test of the board made by laminating tablets according to the embodiment of the present invention; and

FIG. 6 shows the results of 3-point bend test of the board enhanced with carbon fiber according to the embodiment of the present invention

### BEST MODE

Various exemplary embodiments of the invention are fully discussed hereinafter with reference to the accompanying drawings.

In this specification, shell refers to the shell of shellfish and the shellfish is a generic name for mollusks belonging to shellfish class. Typical shellfish includes oysters, clams, Manila clams, blood clams, abalone and so forth. Over hundreds of millions of years, these shells have evolved to have ‘brick and mortar’ structure of micro-tablets and have been found to be 3000 times stronger in fracture toughness. In this embodiment, shells are used due to their features and the shells dumped on the coast can be used so that environmental problems can be solved at the same time.

The micro-tablets of a shell are arranged in ‘brick and mortar’ structure so that the shell has strong mechanical properties. However, since it is extremely difficult to artificially construct it, it can be a good choice to use the method for making meso plates from shells in which micro-tablets are well arranged and then laminated.

The chemical composition of the shell is all calcium carbonate but its outer part has calcite structure with high hardness while its inner part has aragonite structure with relatively low hardness. A calcite is a carbonate anhydrous mineral which has such hexagonal crystal structure that it is easy to produce a plate with beauty owing to its outstanding crystal shape and its various forms. An aragonite is a calcite kind mineral which has orthorhombic crystal structure that an olivine has, but it has higher hardness and higher specific gravity than a calcite has. It is because an aragonite and a calcite have different crystal structures from each other.

So, it is possible to manufacture a material from shells by cutting or peeling calcite parts and aragonite parts from shells to use them depending on the required physical properties or the required uses of the materials, and adjusting and properly mixing their thickness, size, shape, etc.

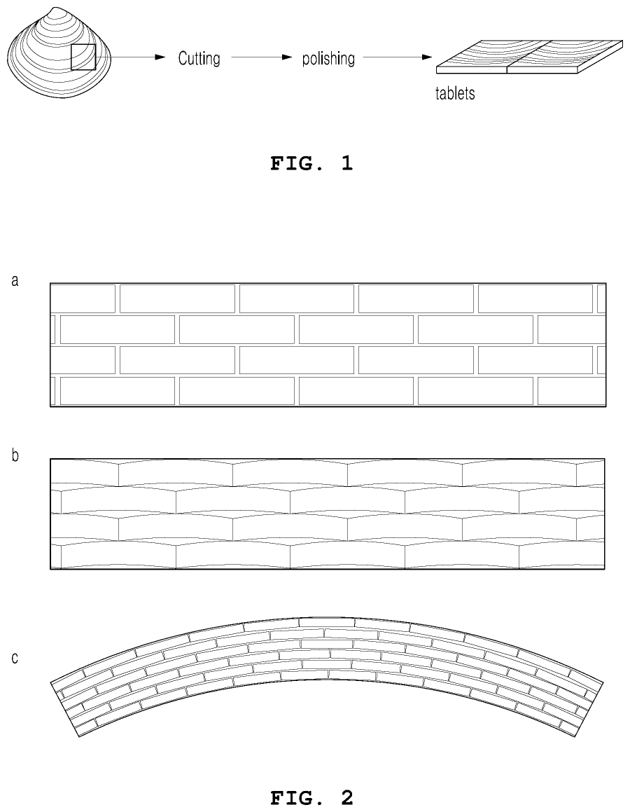

FIG. 1 depicts a conceptual view of making tablets from shells according to an embodiment of the present invention. Tablets with desired size and width are prepared in various ways including a method to cut and polish shells. The material of the tablets can be natural or artificial materials which have the structure that shells have or the structure similar to that of the shells. The tablets are laminated in zigzag so as to enhance or adjust the final physical properties of the material.

FIG. 2 depicts a cross-section view of laminating and rearrange the tablets made as shown FIG. 1 in zigzag. FIG. 2 shows a part of final 3-dimensional material and it does not have to be flat as shown in FIG. 2. In this manner, the 3-dimensional materials with various shapes, sizes, and properties can be manufactured.

FIG. 2a illustrates a case in which flat middle tablets are laminated in zigzag. FIG. 2b shows a case in which the middle tablets processed to have constant curved surface are laminated in zigzag. The space between the middle tablets is filled with an adhesive. The middle tablets can be flat as shown in FIG. 2a, or have various shapes including curved surfaces to control various physical properties as shown in FIG. 2b. The final material can have various shapes including curved surfaces as shown in FIG. 2c. Since the final material is not a single body but can be manufactured by laminating the combination or mixture of the tablets that have various sizes and thickness, its final shape can be 3-dimensional construction as well as flat. Various laminating methods such as surface mounting technology, 3D printing, pen writing, etc. are available depending on the shape, size and thickness of the tablets. In order to make a final material in an predetermined 3-dimensional shape, The final material can be made to have the predetermined 3-dimensional shape by laminating the tablets on the surface of a mold which has a predefined shape or by laminating tablets in an arbitrary shape and applying pressure only or applying pressure and heat together to the laminated tablets with a mold which has the final shape.

FIG. 3 shows strips of shells cut from a shell, thinned strips, and a lightweight high-strength board made by laminating tablets made from the strips according to the embodiment of the present invention. FIG. 3a shows strips cut to a size of some centimeters. FIG. 3b shows strips cut to a size of some millimeters and finely polished. FIG. 3c shows a board made by laminating the tablets made from the strips shown in FIG. 3b. The board is only an embodiment. Not only a board but also a final material that has any 3-dimensional shape can be manufactured.

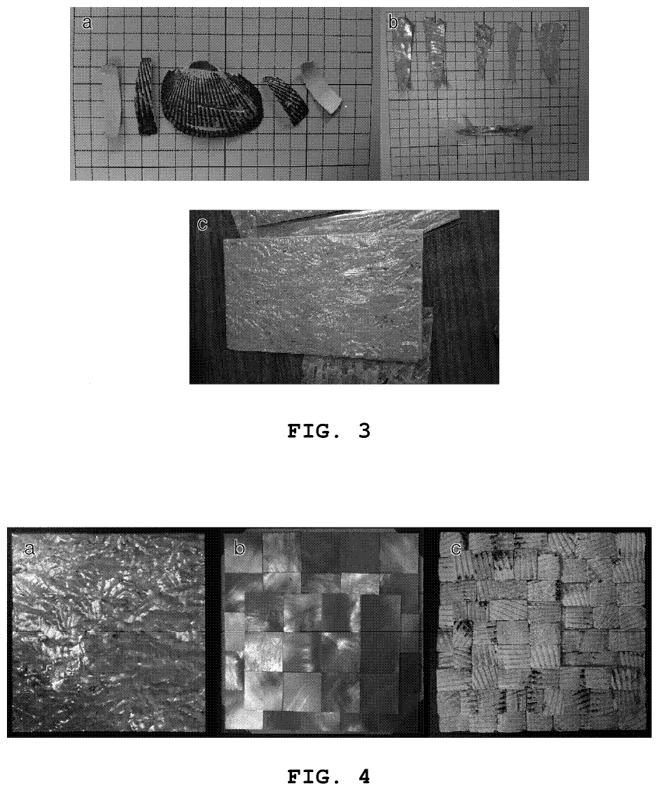

FIG. 4 shows final boards made by laminating the tablets in zigzag according to the embodiment of the present invention. FIG. 4a shows a board made by laminating tablets of a size of some millimeters. FIG. 4b shows a board made by laminating tablets of a size of some centimeters. FIG. 4c shows a board made by laminating tablets of a size of some centimeters without polishing them.

The structure in which such tablets are rearranged enhances its mechanical strength because it prevents a crack from going further when impact is applied. This structure may mimic hierarchical structure in their form.

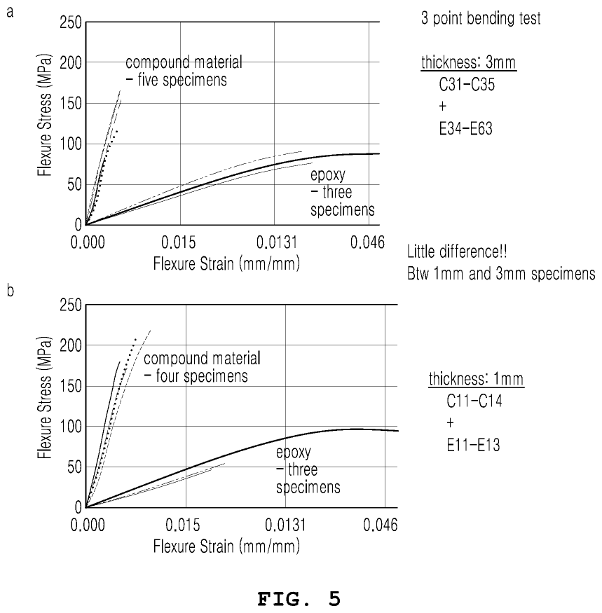

FIG. 5 shows the results of 3-point bend test of the board carried out by laminating tablets to make a board, making specimens meeting standards, and applying force on the center part of each specimen to bend the specimens according to the embodiment of the present invention. The x-axis shows the ratio of the difference between the final stretched length and the original length to the original length when the force is applied to the specimen, and the y-axis shows the force applied to each specimen. The slopes of the curves are Young's moduli, which show the forces required to extend their lengths. FIG. 5a shows the result when the specimen is 3 mm thick. FIG. 5b shows the result when the specimen is 1 mm thick. In FIG. 5a, the five lines show the test result of the specimens made by laminating the tablets with an epoxy as an adhesive while the lower three lines show the test result of the specimens made without any tablets but with expoxy only. This result means that its strength is greatly increased when the tablets are laminated with epoxy. FIG. 5 only shows the strengths of the specimens according to the embodiment but this invention is not limited thereto.

A urethane-based adhesive such as epoxy, gelatinous glue, etc. is used to adhere tablets but the adhesive is not limited thereto. Depending on the required final physical properties, the amount and thickness of the adhesive, the pressure of press, the rolling pressure, curing temperature and duration, etc. can be controlled and adjusted. The tablets can be adhered various way. They can be adhered with epoxy only, with pressure, or with heat.

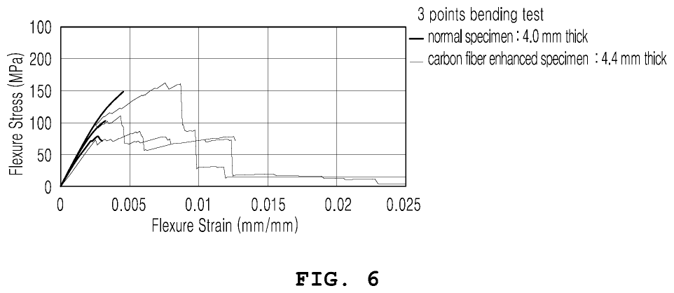

FIG. 6 shows the results of 3-point bend test of the board manufactured by making tablets in the form of flat plates, inserting carbon fiber prepregs between the flat plates, and laminating the tablets with epoxy according to the embodiment of the present invention. The normal specimens without carbon fiber prepregs are 4 millimeters thick while the carbon fiber enhanced specimens are 4.4 millimeters thick. The strengths and Young's moduli of the normal specimens without the carbon fiber prepregs are similar to those of the carbon fiber enhanced specimens respectively regardless of carbon fiber enhancement, while the flexure strains of the carbon fiber enhanced specimens are far bigger than those of the normal specimens without carbon fiber prepregs. This result only shows the possibility of application of various technologies to the method proposed in the present invention but the present invention is not limited thereto.

Although the carbon fiber prepregs are inserted between the tablets made in the form of flat plates in this embodiment, the mechanical properties can be controlled by mixing an adhesive such as epoxy with the fiber fragments made from glass or carbon

### Embodiment 1: Making Tablets

Since the tablets (1 cm×1 cm×0.1 cm for instance) are cut out of shells. Such a tablet is formed of about 100 millions of micro-tablets (10 μm×10 μm×0.5 μm for instance) laminated in ‘brick and mortar’ structure, it has excellent mechanical properties.

### Embodiment 2: Making Boards

The boards (10 cm×10 cm×1 cm for instance) are made by making tablets of a uniform size and laminating them with an adhesive such as epoxy in ‘brick and mortar’ structure.

### Embodiment 3: Making Fiber Enhanced Boards

After the plates (10 cm×10 cm×0.1 cm for instance) are made by making tablets of a uniform size and laminating them with an adhesive such as epoxy in ‘brick and mortar’ structure to make a board, the fiber enhanced boards (10 cm×10 cm×1 cm) are made by inserting carbon fiber prepregs between the plates and adhering the plates with epoxy.

Although the embodiments of the present invention are described in detail above, they are merely preferred implementation to those skilled in the art. So, the scope of the present invention is not limited thereto. Therefore, the substantial scope of the present invention is defined by the appended claims and the equivalents thereof.

1. A method for manufacturing lightweight high-strength material, comprising the steps of:
making tablets out of shells; and
laminating and rearranging said tablets.

2. The method of claim 1, wherein said laminated and rearranged structure is hierarchical structure.

3. The method of claim 1, wherein said tablets are adhered with an adhesive so as to be laminated and rearranged.

4. The method of claim 1, wherein said step of laminating and rearranging said tablets is performed using surface mounting technologies or 3D printing techniques.

5. The method of claim 3, wherein said adhesive is epoxy or urethane-based adhesive.

6. The method of claim 5, wherein said adhesive further includes fiber fragments made from glass or carbon.

7. The method of claim 1, wherein said tablets are laminated and rearranged using adhesive and prepregs made from glass or carbon fiber.

8. The method of claim 1, wherein said step of laminating and rearranging said tablets further comprises the step of:
applying heat or pressure to control shape or properties of final material.

9. The method of claim 8, wherein said step of laminating and rearranging said tablets further comprises the step of:
applying additional heat or pressure to control stress caused during manufacturing said final material so as to adjust properties of said final material.

10. Lightweight high-strength material manufactured in the method according to claim 1.
